(19) United States
(12) Patent Application Publication
(10) Pub. No.: US 2008/0271562 A1
(43) Pub. Date: Nov. 6, 2008

(54) Connecting rod for internal combustion engine and method of manufacturing the connecting rod

(75) Inventors: Junichi Yasuhara, Nagoya-shi (JP); Kenji Hayama, Toyota-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, AICHI-KEN (JP)

(21) Appl. No.: 11/898,172

(22) Filed: Sep. 10, 2007

(30) Foreign Application Priority Data
Oct. 12, 2006 (JP) 2006-278394

(51) Int. Cl. F16C 7/00; B21D 53/84

(52) U.S. Cl. 74/579 E; 123/197.3; 29/888.091

(57) ABSTRACT

A small end member constituting a small end, a column member constituting a column portion, and a big end member constituting a big end of a connecting rod are formed as separate members. In addition, the small end member and the big end member are each made of a high-rigidity material, and the column member is made of a high-strength material. These members are integrally bonded by liquid phase diffusion bonding, thus providing a connecting rod that can achieve suppression of stress concentration.

### INCORPORATION BY REFERENCE

The disclosure of Japanese Patent Application No. 2006-278394 filed on Oct. 12, 2006, including the specification, drawings and abstract is incorporated herein by reference in its entirety.

### BACKGROUND OF THE INVENTION

1. Field of Invention

The present invention relates to a connecting rod employed in an internal combustion engine, such as an automobile engine, and more specifically to a connecting rod formed by a composite of different kinds of material, and a method of manufacturing the connecting rod.

2. Description of Related Art

As described in Japanese patent application publication Nos. JP-A-2000-179535 and JP-A-2001-18056, in an internal combustion engine such as an automobile engine, a piston and a crankshaft are connected to each other by a connecting rod, and the explosive force of an air-fuel mixture during the combustion stroke is transmitted to the crankshaft via the piston and the connecting rod.

As shown in FIG. 9, the above-mentioned connecting rod generally includes a small end b on the piston side, a big end c on the crankshaft side, and a column portion d connecting between the small end b and the big end c. Further, a piston pin hole b1 is formed in the small end b through which a piston pin for connecting a piston e (indicated by an imaginary line in FIG. 9) is inserted. At the big end c, a crankshaft bearing hole c1 is formed in which a crankpin f of the crankshaft is positioned. The big end c has a two-part structure including a big-end main body c2 and a cap c3. A semi-arcuate bearing metal g is fitted onto the inner surface of each of the big-end main body c2 and cap c3. Further, when the crankpin f is placed within the crankshaft bearing hole c1 formed between the big-end main body c2 and the cap c3, the two members (the big-end main body c2 and the cap c3) are fastened to each other with cap bolts h.

As for the method of manufacturing this connecting rod CR, it is common to forge steel to integrally form the small end b, the column portion d, and the big end c. Examples of the material forming the connecting rod CR include nickel chrome steel, chrome molybdenum steel, and titanium alloy.

Because the connection rod CR is a member for transmitting the explosive force of the air-fuel mixture mentioned above, it is necessary to ensure that the connecting rod CR has sufficient rigidity and strength. In addition, since it is a member that moves at high speed (reciprocates within the cylinder on the small end b side, and revolves around the crankshaft on the big end c side), the connecting rod CR should be lightweight.

As an example of a connecting rod manufactured by taking these points into consideration, Japanese patent application publication No. JP-A-63-199916 describes a structure in which the column portion, and the small and big ends are formed as separate members in advance, respectively from a high-strength and high-rigidity material (sintered steel) and from lightweight alloy (quenched aluminum alloy), and a member constituting the column portion (column member), a member constituting the small end (small end member), and a member constituting the big end (big end member) are mechanically connected to be formed in one piece. Examples of described methods for accomplishing this mechanical connection include plastically deforming the materials of the small end member and big end member by forging for engagement and integration with the column member, as well as mating utilizing residual stress.

However, with the connecting rod described in Japanese patent application publication No. JP-A-63-199916 described above, the column member, the small end member, and the big end member are simply mechanically connected together, so there is a high possibility that stress concentration will occur at the connecting portions of the respective members. In particular, unlike a common mechanical part, a connecting rod is used under an operating environment where a very large load (explosive force of an air-fuel mixture) intermittently acts on the connecting rod, and therefore, the connecting rod must be designed so as to be able to withstand this repeated stress with very large fluctuations. Accordingly, a design that enables stress dispersion is required. In this case, when the column member, the small end member, and the big end member are to be mechanically connected together, such a design may be accomplished by increasing the thickness at the connecting portions of the respective members. However, this leads to an increase in the weight of the connecting rod, which reduces the positive effect of using the above-mentioned lightweight alloy.

Further, in the case of the configuration described in JP-A-Sho 63-199916 mentioned above, the small end and the big end may not have sufficient rigidity. In this case, a gap is produced between the small end and the piston pin and between the big end and the crankpin, and thus collision occurs between these members, generating so-called impact sound. This presents a major obstacle to reducing noise and vibration of an engine.

### SUMMARY OF THE INVENTION

The present invention provides a technique that can secure sufficient rigidity and strength for respective portions of a connecting rod while achieving both a reduction in the weight of the connecting rod and suppression of stress concentration.

A first aspect of the present invention relates to a connecting rod for connecting a piston and a crankshaft to each other and transmitting to the crankshaft an explosive force of an air-fuel mixture received from the piston during a combustion stroke of an internal combustion engine. A plurality of connecting rod constituent members made of different kinds of material and formed as separate parts are integrally bonded to the connecting rod by diffusion bonding.

According to this arrangement, as compared with a connecting rod in which the column member, the small end member, and the big end member are mechanically connected together, the bonding portions of the connecting rod constituent members are integrated together by diffusion bonding with their microstructures (metallographic structures) fused together, thereby making it possible to reduce the degree of stress concentration at respective portions of the connecting rod. This eliminates the need to increase the thickness to achieve stress dispersion. Therefore, sufficient strength and rigidity can be secured for respective portions without increasing the weight of the connecting rod, thereby making it possible to sufficiently satisfy performance requirements placed on the connecting rod, such as high strength, high rigidity, and light weight.

A second aspect of the present invention relates to a connecting rod for an internal combustion engine, including a small end connected to a piston, a big end connected to a crankpin, and a column portion extending between the small end and the big end. In this connecting rod, a small end member that forms the small end and a column member that forms the column portion are initially formed as separate members made of different kinds of material, and are integrally bonded by diffusion bonding.

A third aspect of the present invention relates to a connecting rod for an internal combustion engine, including a small end connected to a piston, a big end connected to a crankpin, and a column portion extending between the small end and the big end. In the connecting rod, a big end member that forms the big end and a column member that forms the column portion are initially formed as separate members made of different kinds of material, and are integrally bonded by diffusion bonding. Further, the column member may be integrally bonded with the small end member by diffusion bonding. The constituent material of the small end member may be the same as the constituent material of the big end member.

Further, the constituent materials of the small end member, column member, and big end member may be different from each other. According to this arrangement, the degree of stress concentration at the bonding portion between the small end member and the column member and at the bonding portion between the big end member and the column member can be reduced. Therefore, in this case well, there is no need to increase the thickness to achieve stress dispersion. As a result, sufficient strength and rigidity can be secured for respective portions without increasing the weight of the connecting rod, thereby making it possible to sufficiently satisfy performance requirements placed on the connecting rod, such as high strength, high rigidity, and light weight.

Further, specific examples of the constituent material applied to each portion are given below. First, if the small end member and the column member are to be bonded by diffusion bonding, the constituent material of the small end member has a higher rigidity than the constituent material of the column member, and the constituent material of the column member has a higher strength than the constituent material of the small end member.

Further, if the big end member and the column member are to be bonded by diffusion bonding, the constituent material of the big end member has a higher rigidity than the constituent material of the column member, and the constituent material of the column member has a higher strength than the constituent material of the big end member.

Further, if the small end member and the column member, and the big end member and the column member are to be respectively bonded by diffusion bonding, the constituent materials of the small end member and big end member has a higher rigidity than the constituent material of the column member, and the constituent material of the column member has a higher strength than the constituent materials of the small end member and big end member.

According to this arrangement, high rigidity is secured for the small end and the big end, thereby making it possible to prevent a gap from being produced between the small end and the piston pin, and between the big end and the crankpin. Generation of impact noise due to the collision of these members is thus effectively avoided, thereby reducing noise and vibration of the engine. Further, because high rigidity is secured for the column portion, the column portion effectively transmits the explosive force of an air-fuel mixture to the crankshaft, and can sufficiently withstand the above-mentioned explosive force that intermittently acts on the column portion, thereby making it possible to improve the durability of the connecting rod.

Further, the positions of the bonding surfaces that are bonded to each other by the above-mentioned diffusion bonding may be set as follows, for example. First, in a case where the small end member and the column member are bonded, the bonding surface may be formed to conform to the outer edge shape of the small end (see a bonding surface 2B, 4B in FIG. 2). Alternatively, the bonding surface may be formed to extend from the inner edge of the small end to the outer edge of the column portion (see a bonding surface 2B, 4B in FIG. 3), or may be formed as a surface that is orthogonal to the axis of the connecting rod at a position of the column portion near the small end (see a bonding surface 2B, 4B in FIG. 5).

Second, in a case where the big end member and the column member are bonded, the bonding surface may be formed as a surface that conforms to the outer edge shape of the big end (see a bonding surface 3B, 4C in FIG. 2), a surface that extends from the inner edge of the big end to the outer edge of the column portion (see a bonding surface 3B, 4C in FIG. 3), or a surface that is oriented orthogonal to the axis of the connecting rod at a position of the column portion near the big end (see a bonding surface 3B, 4C in FIG. 5).

Third, in a case where the small end member and the big end member are to be respectively bonded to the column member by diffusion bonding, the bonding surface may be formed as a surface that conforms to the outer edge shape of the small end and a surface that conforms to the outer edge shape of the big end (see a bonding surface 2B, 4B and a bonding surface 3B, 4C in FIG. 2), a surface that extends from the inner edge of the small end to the outer edge of the column portion and a surface that extends from the inner edge of the big end to the outer edge of the column portion (see a bonding surface 2B, 4B and a bonding surface 3B, 4C in FIG. 3), or may be formed as a surface that is oriented orthogonal to the axis of the connecting rod at a position of the column portion near the small end or a surface that is oriented orthogonal to the axis of the connecting rod at a position of the column portion near the big end (see a bonding surface 2B, 4B and a bonding surface 3B, 4C in FIG. 5).

A fourth aspect of the present invention relates to a method of manufacturing a connecting rod for an internal combustion engine. The manufacturing method includes the steps of manufacturing a first member from a first constituent material, manufacturing a second member from a second constituent material, and integrally bonding the first member and the second member by diffusion bonding.

According to the present invention, a plurality of connecting rod constituent members (for example, the small end member, the big end member, and the column member) as separate members are made of different kinds of metal, and these members are bonded by diffusion bonding. It is thus possible to reduce the degree of stress concentration that would occur when mechanically connecting these members as mentioned above, and hence there is no need to increase the thickness to achieve stress dispersion. Therefore, sufficient strength and rigidity can be secured for respective portions without increasing the weight of the connecting rod, thereby making it possible to provide a connecting rod that can sufficiently satisfy such requirements as high strength, high rigidity, and light weight.

### BRIEF DESCRIPTION OF THE DRAWINGS

The foregoing and further, features and advantages of the invention will become apparent from the following description of example embodiments with reference to the accompanying drawings, wherein like numerals are used to represent like elements and wherein:

FIG. 1 is a front view of a connecting rod according to a first embodiment;

FIG. 2 is a view showing a state before a small end member, a big end member, and a column member are integrally bonded together according to the first embodiment;

FIG. 3 is a view showing a state before a small end member, a big end member, and a column member are integrally bonded together according to a second embodiment;

FIG. 4 is a front view of a connecting rod according to the second embodiment;

FIG. 5 is a view showing a state before a small end member, a big end member, and a column member are integrally bonded together according to a third embodiment;

FIG. 6 is a front view of a connecting rod according to the third embodiment;

FIG. 7 is a view showing a state before a small end member, a big end member, and a column member are integrally bonded together according to a first modification;

FIG. 8 is a view showing a state before a small end member, a big end member, and a column member are integrally bonded together according to a second modification; and

FIG. 9 is a view of a connecting rod according to the related art as viewed along the crank axis.

### DETAILED DESCRIPTION OF THE PREFERRED EMBODIMENTS

Embodiments of the present invention will now be described with reference to the drawings. In the following embodiments, description will be given of the present invention as applied to a connecting rod for an automobile reciprocating engine.

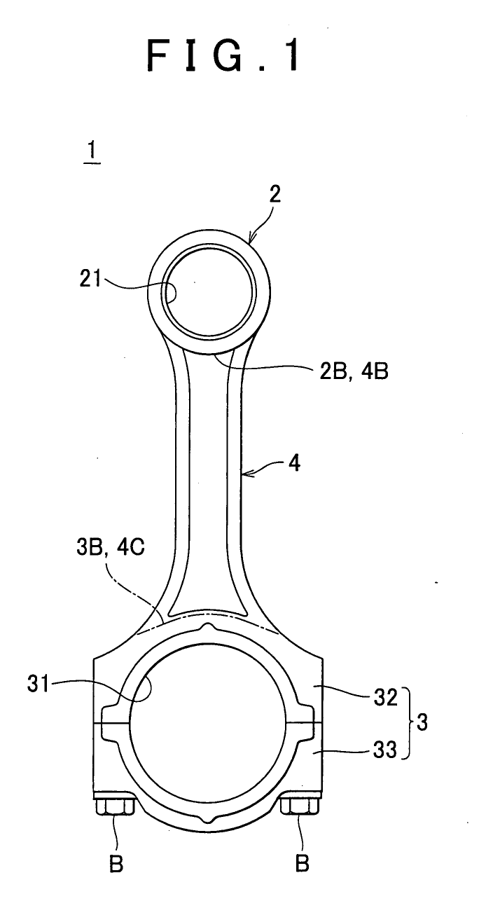

FIG. 1 is a front view of a connecting rod 1 according to this embodiment (a view as seen from a direction along the crankshaft axis with the connecting rod 1 connected to a crankshaft).

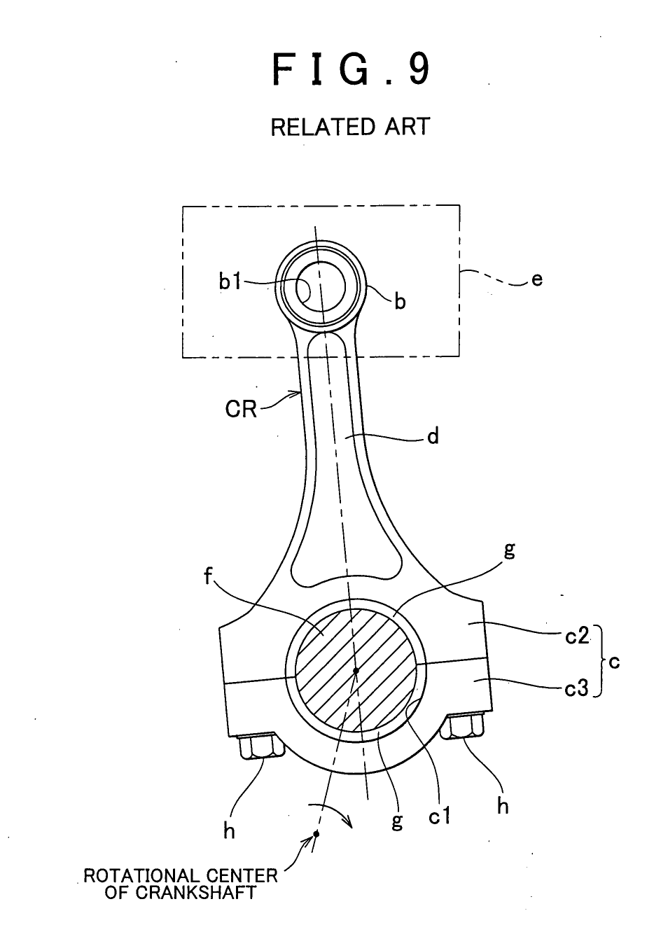

As shown in FIG. 1, the major components of the connecting rod 1 according to this embodiment are substantially the same as those of the connecting rod shown in FIG. 9. These components will be briefly described below.

The connecting rod 1 includes a small end 2 on the piston side, a big end 3 on the crankshaft side, and a column portion 4 connecting between the small end 2 and the big end 3.

The small end 2 has formed with a piston pin hole 21 through which a piston pin for connecting a piston is inserted. On the other hand, the big end 3 has formed therein a crankshaft bearing hole 31 in which a crankpin of the crankshaft is positioned. The big end 3 has a two-part structure including a big-end main body 32 and a cap 33. A pair of upper and lower semi-arcuate bearing metals (not shown) are fitted onto the inner surfaces of the big-end main body 32 and cap 33, respectively. Further, in a state with the crankpin placed within the crankshaft bearing hole 31 formed between the big-end main body 32 and the cap 33, the two members (the big-end main body 32 and the cap 33) are fastened to each other with cap bolts B.

In this way, the connecting rod 1 connects the piston and the crankpin of the crankshaft to each other. During operation of the engine, the piston makes a reciprocating motion within a cylinder (not shown), and that motion is converted into rotary motion of the crankshaft by the connecting rod 1. The resulting rotational force is obtained as the engine output.

The connecting rod 1 according to this embodiment is a composite of different kinds of metal (different constituent materials). This will be described more specifically below. As described above, the connecting rod 1 includes the small end 2, the big end 3, and the column portion 4. A characteristic feature of the connecting rod 1 according to this embodiment resides in that these portions are individually formed as separate members in advance, and the connecting rod 1 is formed by bonding these members integrally together.

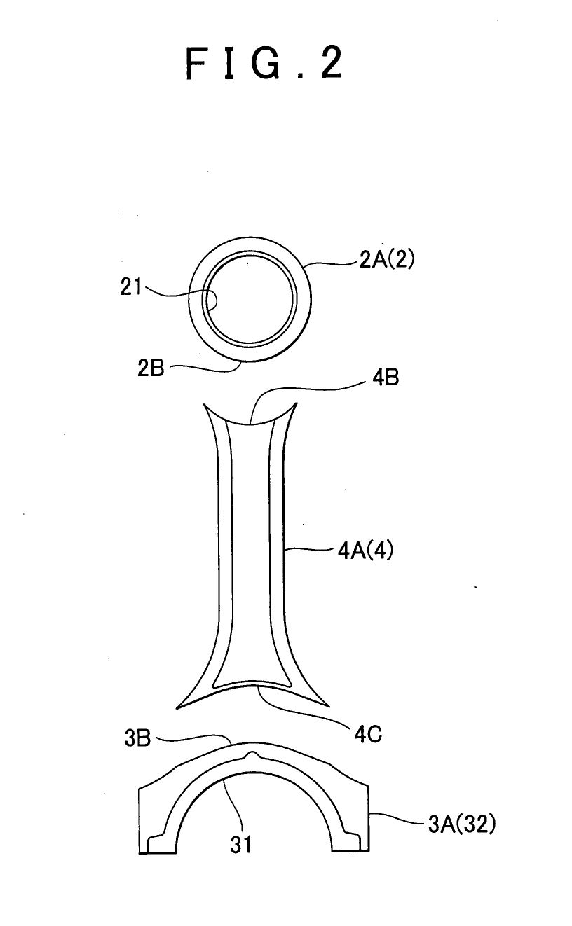

FIG. 2 shows a state before the small end 2, the big-end main body 32 of the big end 3, and the column portion 4 are integrally bonded together. In the following description, a member that serves as the small end 2, a member that serves as the big-end main body 32 of the big end 3, and a member that serves as the column portion 4 will be respectively referred to as a small end member 2A, a big end member 3A, and a column member 4A. Each one of these members 2A, 3A, and 4A can be regarded as the “connecting rod constituent members” according to the present invention.

Further, the small end member 2A and the big end member 3A are made of the same constituent material. The column member 4A is formed of a constituent material (hereinafter, referred to “column-portion constituent material”) that differs from the constituent material of the small end member 2A and big end member 3A (“end constituent material”).

When the end constituent material and the column-portion constituent material are compared, the end constituent material has a higher rigidity that that of the column-portion constituent material (in this specification, “rigidity” is used to refer to the resistance of the material to deformation), and the column-portion constituent material has a higher strength than that of the end constituent material (in this specification, “strength” is used to refer to the resistance of the material to breaking). Description will now be given of a plurality of examples of specific metal material employed as the end constituent material and the column-portion constituent material.

### Example 1

The end constituent material is TiB₂, and the column-portion constituent material is steel containing vanadium.

### Example 2

The end constituent material is steel, and the column-portion constituent material is titanium alloy.

### Example 3

The end constituent material is steel containing titanium alloy, and the column-portion constituent material is titanium alloy.

### Example 4

The end constituent material is steel containing titanium alloy, and the column-portion constituent material is steel.

According to these material combinations, the rigidity of the constituent material of the small end member 2A and big end member 3A is high in comparison to the constituent material of the column member 4A, and the strength of the constituent material of the column member 4A is high in comparison to the constituent material of the small end member 2A and big end member 3A. It should be noted that the present invention is not limited to the materials described above, and that any combination of materials may be employed as long as the rigidity of the constituent material of the small end member 2A and big end member 3A is higher that the constituent material of the column member 4A, and the strength of the constituent material of the column member 4A higher than the constituent material of the small end member 2A and big end member 3A.

In this embodiment, liquid phase diffusion bonding is employed as the method for producing the connecting rod 1 by integrally bonding the small end member 2A, the big end member 3A, and the column member 4A formed as described above.

Liquid phase diffusion bonding will now be briefly described. Liquid phase diffusion bonding is a method effectively used to bond different metals or metallic materials together. In liquid phase diffusion bonding, a metal layer (insert metal) that lowers the melting point of metal members to be bonded together is interposed between these metal members (for example, the insert metal may be plated on the surface of one of the metal members in advance and the other metal member is pressed onto the plated portion), and each of the metal members is heated to the vicinity of its melting point. Accordingly, first, a melting-point-lowering element as the above-mentioned insert metal diffuses into the metal material of the metal member, causing the metal in the vicinity of the bonding surface to melt. Thereafter, isothermal solidification proceeds as the melting-point-lowering element diffuses further into the liquid phase, thus achieving firm bonding. That is, bonding is effected by the atoms in the respective materials moving (diffusing) to each other across the contact surface of the metal members. This bonding method is particularly suitable for bonding of titanium or titanium alloy.

The above-mentioned method may be employed as the method for integrally bonding the small end member 2A, the big end member 3A, and the column member 4A together. That is, from the state shown in FIG. 2, the bonding surfaces of the respective members 2A, 3A, and 4A are contacted with each other, followed by application of pressure to attain the state shown in FIG. 1. That is, a bonding surface 2B of the small end member 2A with respect to the column member 4A and a bonding surface 4B of the column member 4A with respect to the small end member 2A are contacted with each other, and a bonding surface 3B of the big end member 3A with respect to the column member 4A and a bonding surface 4C of the column member 4A with respect to the big end member 3A are contacted with each other. In FIG. 1, the bonding surfaces 3B, 4C between the big end member 3A and the column member 4A are indicated by alternate long and short dashed lines.

In this state, each of these three members 2A, 3A, and 4A is heated to the vicinity of the melting point of its constituent material (melting point of the material on the low melting-point side), thereby bonding the bonding surface 2B of the small end member 2A and the bonding surface 4B of the column member 4A, and the bonding surface 3B of the big end member 3A and the bonding surface 4C of the column member 4A to each other by the above-mentioned liquid phase diffusion bonding. That is, the small end 2, the big-end main body 32 of the big end 3, and the column portion 4 are integrated together as shown in FIG. 1. Then, the connecting rod 1 is prepared by fastening the cap 33 of the big end 3 onto this integrated structure with the cap bolts B.

Further, a shot peening process is applied to the connecting rod 1 having the small end member 2A, the big end member 3A, and the column member 4A thus integrated together, thereby improving strength. The shot peening process may be applied only to the bonding portion between the small end member 2A and the column member 4A and its vicinity or the bonding portion between the big end member 3A and the column member 4A and its vicinity, or may be applied to the entirety of the connecting rod 1.

As described above, in this embodiment, the small end member 2A and the big end member 3A, which are each formed of an end constituent material that is higher in rigidity than the column-portion constituent material, and the column member 4A formed of the column-portion constituent material that is higher in strength than the end constituent material, are integrally bonded together by liquid phase diffusion bonding to form the connecting rod 1. Therefore, as compared with a case where the column portion, the small end, and the big end are mechanically connected together, the metallographic structure at each of the bonding portion between the small end 2 and the column portion 4 and the bonding portion between the big end 3 and the column portion 4 is made continuous, thereby making it possible to reduce the degree of stress concentration. This eliminates the need for employing a method such as relieving stress by increasing the thickness at this bonding portion. Therefore, sufficient strength and rigidity required for respective portions can be secured without increasing the weight of the connecting rod 1, thereby making it possible to sufficiently satisfy requirements placed on the connecting rod 1, such as high strength, high rigidity, and lightweightness. In particular, because high rigidity is secured for the small end 2 and the big end 3, it is possible to prevent gaps from being produced between the small end 2 and the piston pin, and between the big end 3 and the crankpin. Generation of impact noise due to the collision of these members is effectively reduced, thereby reducing noise and vibration of the engine.

Next, a second embodiment will be described. In this embodiment, the shapes of the small end member 2A, big end member 3A, and column member 4A are different from those of the first embodiment described above. Because the configuration, the constituent materials, and the bonding method according to the second embodiment are the same as those according to the first embodiment, here, description will be made only with regard to the shapes of the small end member 2A, big end member 3A, and column member 4A.

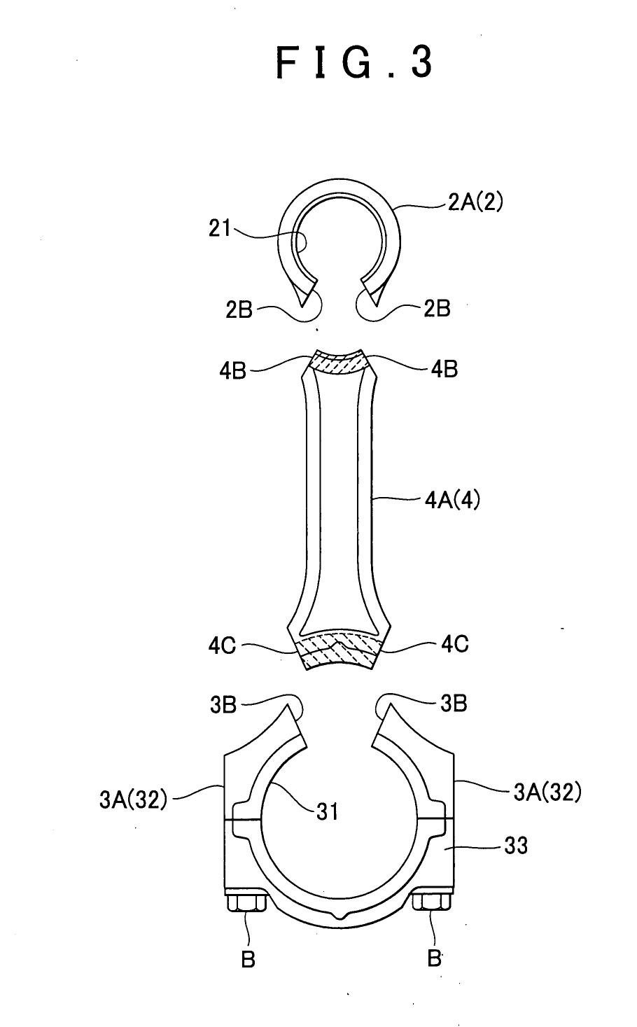

FIG. 3 shows a state before the small end member 2A, the big end member 3A, and the column member 4A are bonded to each other.

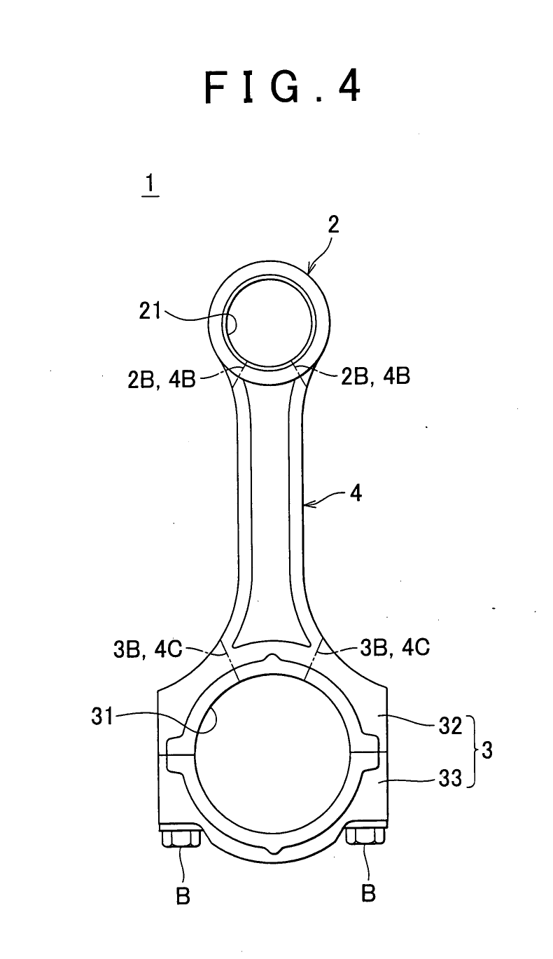

As shown in FIG. 3, in the column member 4A according to this embodiment, a part (portion indicated by diagonal broken lines in FIG. 3) of its upper end portion (portion on the small end 2 side) constitutes a part (lower end) of the small end 2, and a part (portion similarly indicated by diagonal broken lines in FIG. 3) of its lower end portion (portion on the big end 3 side) constitutes a part (upper end) of the big end 3. In other words, as indicated by alternate long and short dashed lines in FIG. 4, the boundary line (bonding surface 2B, 4B) between the small end member 2A and the column member 4A extends from the inner peripheral edge of the small end 2 to the outer edge of the column portion 4. Further, the boundary line (bonding surface 3B, 4C) between the big end member 3A and the column member 4A extends from the inner peripheral edge of the big end 3 to the outer edge of the column portion 4.

The second embodiment is the same as the above-mentioned first embodiment in that the small end member 2A, the big end member 3A, and the column member 4A are bonded to each other by liquid phase diffusion bonding to prepare the connecting rod 1. However, in this embodiment, because the bonding surface 3B of the big end member 3A is formed as a surface extending from the inner peripheral edge of the big end 3 to the outer edge of the column portion 4, the big end member 3A is split into two parts. Accordingly, as shown in FIG. 3, by fastening each of the split big end members 3A, 3A to the cap 33 in advance, the relative positions between the respective big end members 3A, 3A are set before bonding them to the column member 4A.

In this embodiment as well, as in the first embodiment mentioned above, the small end member 2A and the big end member 3A, which are each formed of the end constituent material, which has a higher rigidity than the column-portion constituent material, and the column member 4A is formed of the column-portion constituent material, which has a higher strength than the end constituent material, are integrally bonded together by liquid phase diffusion bonding to form the connecting rod 1. Therefore, the metallographic structure at each of the bonding portion between the small end 2 and the column portion 4 and the bonding portion between the big end 3 and the column portion 4 is made continuous. It is thus possible to reduce the degree of stress concentration at this bonding portion. This eliminates the need to increase the thickness at this bonding portion in order to relieve stress. Therefore, sufficient strength and rigidity required for respective portions can be secured without increasing the weight of the connecting rod 1, thereby making it possible to sufficiently satisfy requirements placed on the connecting rod 1, such as high strength, high rigidity, and light weight.

In this embodiment, each of the bonding surfaces 2B, 4B, 3B, and 4C extends over an area from the inner peripheral edge of the small end 2 to the outer edge of the column portion 4 or an area from the inner peripheral edge of the big end 3 to the outer edge of the column portion 4. However, each of these bonding surfaces may extend over an area from the inner peripheral edge of the small end 2 to the outer peripheral edge thereof or an area from the inner peripheral edge of the big end 3 to the outer peripheral edge thereof.

Next, a third embodiment will be described. In this embodiment as well, the shapes of the small end member 2A, big end member 3A, and column member 4A are different from those of the first embodiment described above. Because the configuration, the constituent materials, and the bonding method according to the third embodiment are the same as those according to the first embodiment, in this case as well, description will be made only with regard to the shapes of the small end member 2A, big end member 3A, and column member 4A.

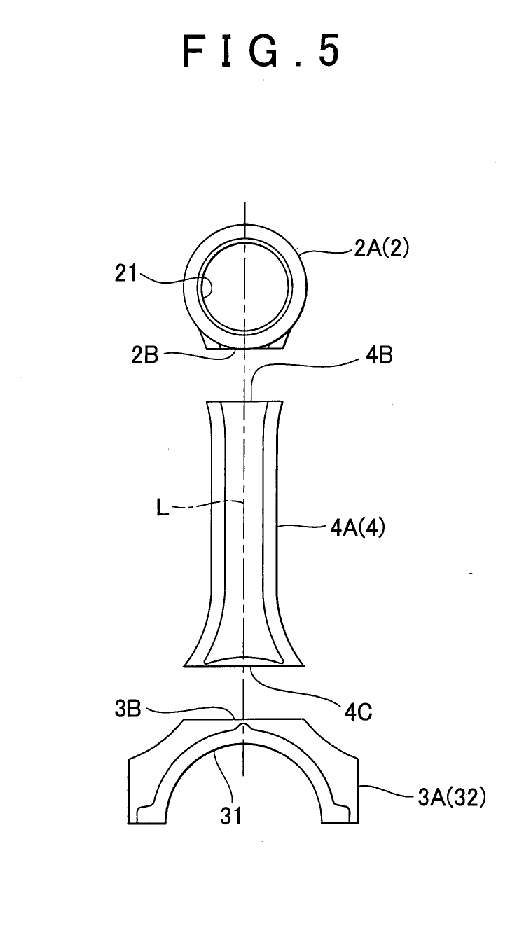

FIG. 5 shows a state before the small end 2A, the big end 3A, and the column portion 4A are integrally bonded to each other.

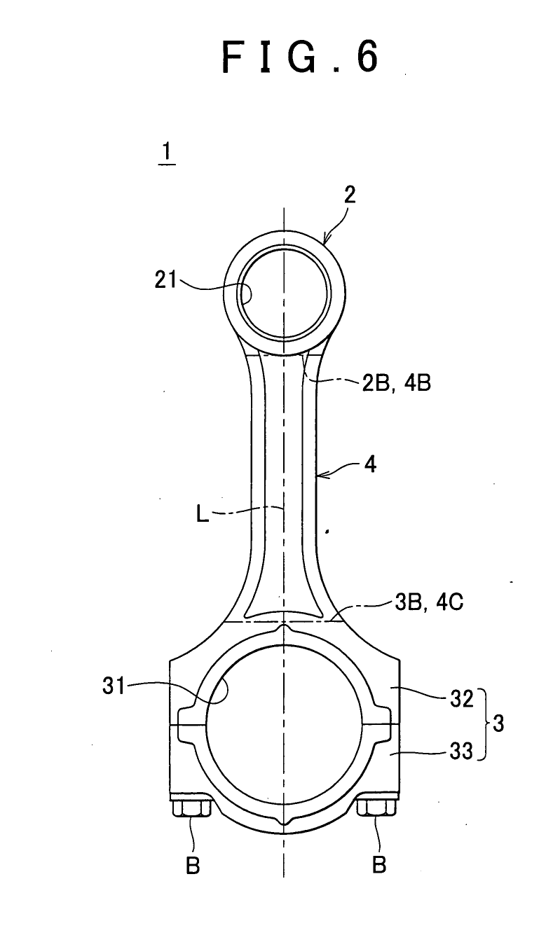

As shown in FIG. 5, in the column member 4A according to this embodiment, a flat surface, formed at its upper end portion (portion on the small end 2 side), extends in a direction orthogonal to the axis L of the connecting rod 1 and serves as the bonding surface 4B with respect to the small end member 2A. Likewise, in the column member 4A, a flat surface formed at its lower end portion (portion on the big end 3 side) and extending in a direction orthogonal to the axis L of the connecting rod 1 serves as the bonding surface 4C with respect to the big end member 3A. On the other hand, the bonding surface 2B of the small end member 2A with respect to the column member 4A is a flat surface that opposes to the bonding surface 4B of the column member 4A, and the bonding surface 3B of the big end member 3A with respect to the column member 4A is a flat surface that opposes to the bonding surface 4C of the column member 4A. That is, as indicated by alternate long and short dashed lines (bonding surface positions) in FIG. 6, the bonding surfaces 2B, 4B, 3B, and 4C are provided at both the upper and lower ends of the column portion 4.

In this embodiment as well, as in each of the embodiments mentioned above, the small end member 2A and the big end member 3A, which are each formed of the end constituent material, which has a higher rigidity than the column-portion constituent material, and the column member 4A formed of the column-portion constituent material, which has a higher strength than the end constituent material, are integrally bonded together by liquid phase diffusion bonding to form the connecting rod 1. Therefore, the metallographic structure at each of the bonding portion between the small end 2 and the column portion 4 and the bonding portion between the big end 3 and the column portion 4 can be made continuous. It is thus possible to reduce the degree of stress concentration at this bonding portion. This eliminates the need to increase the thickness at this bonding portion in order to relieve stress. Therefore, sufficient strength and rigidity required for the respective portions may be secured without increasing the weight of the connecting rod 1, thereby making it possible to sufficiently satisfy requirements placed on the connecting rod 1, such as high strength, high rigidity, and light weight.

Further, according to this embodiment, the bonding surfaces 2B, 4B, 3B, and 4C are all flat surfaces. Accordingly, if pressure is applied between the respective members 2A, 3A, and 4A along the axis L of the connecting rod 1, a uniform contact force may be achieved over the all the bonding surfaces 2B, 4B, 3B, and 4C, and a uniform bonding force may be also achieved between the bonding surfaces 2B, 4B, 3B, and 4C.

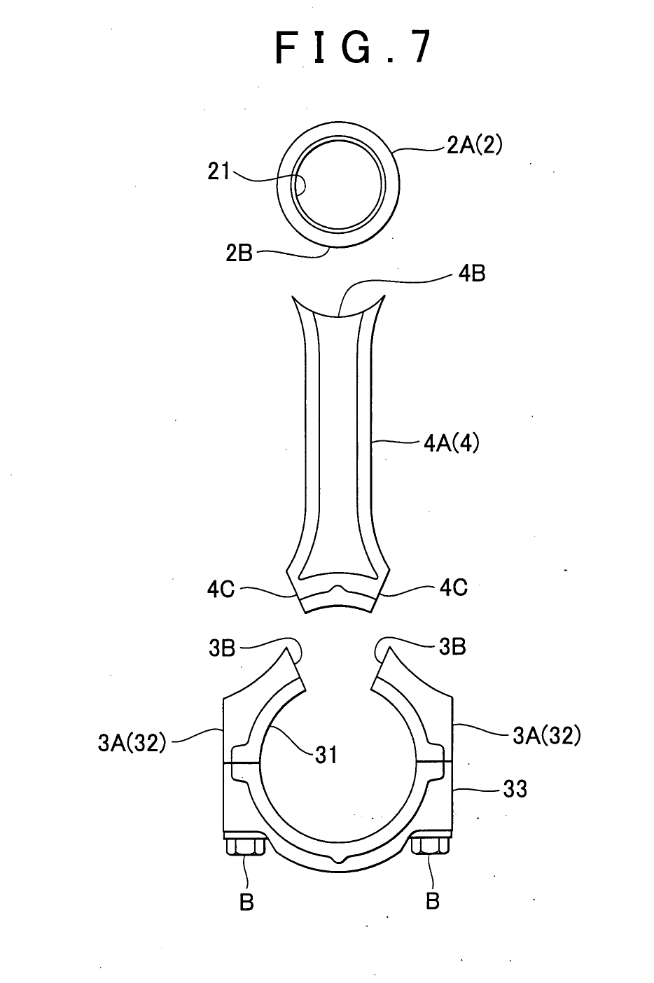

FIG. 7 shows a state before the small end 2A, the big end 3A, and the column portion 4A are bonded to each other according to a first modification. As shown in FIG. 7, according to this modification, the shape of the small end member 2A and the shape of the upper end of the column member 4A, which is bonded to the small end member 2A, are the same as those of the first embodiment mentioned above, and the shape of the big end member 3A and the shape of the lower end of the column member 4A, which is bonded to the big end member 3A, are the same as those of the second embodiment mentioned above. The bonding method for the respective portions is the same as that of each of the embodiments mentioned above.

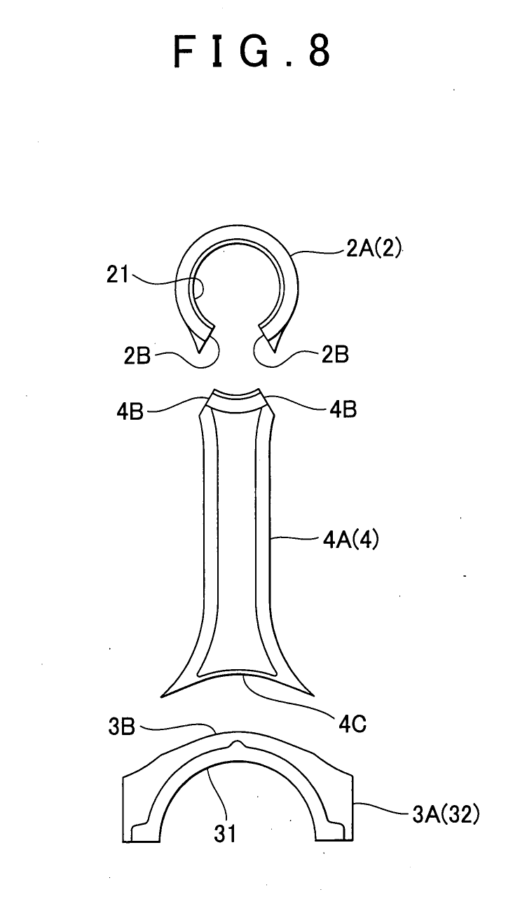

Further, FIG. 8 shows a state before the small end 2A, the big end 3A, and the column portion 4A are bonded to each other according to a second modification. As shown in FIG. 8, according to this modification, the shape of the small end member 2A and the shape of the upper end of the column member 4A, which is bonded to the small end member 2A, are the same as those of the second embodiment mentioned above, and the shape of the big end member 3A and the shape of the lower end of the column member 4A, which is bonded to the big end member 3A, are the same as those of the first embodiment mentioned above.

Further, although not shown, the following configurations may be adopted in addition to the respective modifications described above.

A configuration may be adopted such that the shape of the small end member 2A and the shape of the upper end of the column member 4A, which is bonded to the small end member 2A, are the same as those of the first embodiment mentioned above, and the shape of the big end member 3A and the shape of the lower end of the column member 4A, which is bonded to the big end member 3A, are the same as those of the third embodiment mentioned above.

Another configuration may be adopted such that the shape of the small end member 2A and the shape of the upper end of the column member 4A, which is bonded to the small end member 2A, are the same as those of the second embodiment mentioned above, and the shape of the big end member 3A and the shape of the lower end of the column member 4A, which is bonded to the big end member 3A, are the same as those of the third embodiment mentioned above.

Yet another configuration may be adopted such that the shape of the small end member 2A and the shape of the upper end of the column member 4A, which is bonded to the small end member 2A, are the same as those of the third embodiment mentioned above, and the shape of the big end member 3A and the shape of the lower end of the column-member 4A, which is bonded to the big end member 3A, are the same as those of the first embodiment mentioned above.

Still another configuration may be adopted such that the shape of the small end member 2A and the shape of the upper end of the column member 4A, which is bonded to the small end member 2A, are the same as those of the third embodiment mentioned above, and the shape of the big end member 3A and the shape of the lower end of the column member 4A, which is bonded to the big end member 3A, are the same as those of the second embodiment mentioned above.

While in the above embodiments and modifications description is directed to the case where the present invention is applied to the connecting rod 1 for an automobile engine, the present invention is also applicable to a connecting rod used in other types of internal combustion engines.

Further, while in the above-mentioned embodiments and modifications the small end member 2A and the big end member 3A are made of the same material, the present invention is not limited to this. The small end member 2A and the big end member 3A may be made of different materials. However, in this case as well, each of the constituent material of the small end member 2A and the constituent material of the big end member 3A has a rigidity higher than the rigidity of the constituent material of the column member 4A.

Further, in the above-mentioned embodiments and modifications, the three members, namely the small end member 2A, the big end member 3A, and the column member 4A, are integrally bonded together by diffusion bonding. However, it is also possible to integrally form the column portion 4 and the big end 3 by forging or the like in advance, and then bond the small end member 2A, which is a separate member made of a different kind of material, to the column portion 4 by the diffusion bonding. Likewise, it is also possible to integrally form the column portion 4 and the small end 2 by forging or the like in advance, and then bond the big end member 3A, which is a separate member made of a different kind of material, to the column portion 4 by the diffusion bonding.

What is claimed is:

1. A connecting rod for an internal combustion engine, comprising:
a first member made of a first constituent material; and
a second member made of a second constituent material and integrally bonded with the first member by diffusion bonding.

2. A connecting rod for an internal combustion engine, comprising:
a small end, which is connected to a piston, formed by a small end member made of a first constituent material;
a big end which is connected to a crankpin; and
a column portion, which extends between the small end and the big end, formed by a column member that is made of a second constituent material and that is integrally bonded with the small end member by diffusion bonding.

3. The connecting rod for an internal combustion engine according to claim 2, wherein:
the first constituent material has a higher rigidity than the second constituent material; and
the second constituent material has a higher strength than the first constituent material.

4. The connecting rod for an internal combustion engine according to claim 2, wherein
a bonding surface bonded by the diffusion bonding conforms to an outer edge shape of the small end.

5. The connecting rod for an internal combustion engine according to claim 2, wherein:
the column member forms a part of the small end; and
a bonding surface bonded by the diffusion bonding extends from an inner edge of the small end to an outer edge of the column portion.

6. The connecting rod for an internal combustion engine according to claim 2, wherein:
the column member forms the column portion; and
a bonding surface bonded by the diffusion bonding is orthogonal to an axis of the connecting rod at a position of the column portion near the small end.

7. A connecting rod for an internal combustion engine, comprising:
a small end, which is connected to a piston, formed by a small end member;
a big end, which is connected to a crankpin, formed by a big end member made of a first constituent material; and
a column portion, which extends between the small end and the big end, formed by a column member that is made of a second constituent material and that is integrally bonded with the big end member by diffusion bonding.

8. The connecting rod for an internal combustion engine according to claim 7, wherein:
the first constituent material has a higher rigidity than the second constituent material; and
the second constituent material has a higher strength than the first constituent material.

9. The connecting rod for an internal combustion engine according to claim 7, wherein a bonding surface bonded by the diffusion bonding conforms to an outer edge shape of the big end.

10. The connecting rod for an internal combustion engine according to claim 7, wherein:
the column member forms a part of the big end; and
a bonding surface bonded by the diffusion bonding extends from an inner edge of the big end to an outer edge of the column portion.

11. The connecting rod for an internal combustion engine according to claim 7, wherein
a bonding surface bonded by the diffusion bonding is orthogonal to an axis of the connecting rod at a position of the column portion near the big end.

12. The connecting rod for an internal combustion engine according to claim 7, wherein
the column member is integrally bonded with the small end member by diffusion bonding.

13. The connecting rod for an internal combustion engine according to claim 12, wherein a constituent material of the small end member is different from the first constituent material.

14. The connecting rod for an internal combustion engine according to claim 12, wherein:
the first constituent material and the constituent material of the small end member have higher in rigidities than the second constituent material; and
the second constituent material has a higher strength than the first constituent material and the constituent material of the small end member.

15. The connecting rod for an internal combustion engine according to claim 12, wherein
bonding surfaces bonded by the diffusion bonding conforms to an outer edge shape of the small end and conforms to an outer edge shape of the big end.

16. The connecting rod for an internal combustion engine according to claim 12, wherein:
the column member forms a part of the small end and a part of the big end; and
a bonding surface bonded by the diffusion bonding extends from an inner edge of the small end to an outer edge of the column portion and extends from an inner edge of the big end to the outer edge of the column portion.

17. The connecting rod for an internal combustion engine according to claim 12, wherein:
a bonding surface bonded by the diffusion bonding at a position of the column portion near the small end is orthogonal to an axis of the connecting rod; and
a bonding surface bonded by the diffusion bonding at a position of the column portion near the big end is orthogonal to the axis of the connecting rod.

18. A connecting rod for an internal combustion engine, comprising:
a first constituent member made of a first material;
a second constituent member made of a second material; and
a portion interposed between the first member and the second member in which the first constituent material and the second constituent material are diffused.

19. A method of manufacturing a connecting rod for an internal combustion engine, comprising:
manufacturing a first member from a first constituent material;
manufacturing a second member from a second constituent material; and
integrally bonding the first member and the second member by diffusion bonding.

20. The method of manufacturing a connecting rod according to claim 19, wherein:
the first member is a small end member that forms a small end connected to a piston;
the second member includes a column member that forms a column portion that extends between the small end and a big end connected to a crankpin; and
the column member and the small end member are integrally bonded by diffusion bonding.

21. The method of manufacturing a connecting rod according to claim 20, wherein
a bonding surface bonded by the diffusion bonding conforms to an outer edge shape of the small end.

22. The method of manufacturing a connecting rod according to claim 20, wherein:
the small end member is formed in a shape in which a portion of the small end is partially cut out;
the column member is formed to include an end portion that corresponds to the cutout portion of the small end; and
the cutout portion of the small end member and the end portion of the column member are bonded by diffusion bonding.

23. The method of manufacturing a connecting rod according to claim 20, wherein
a bonding surface of the small end member with the column member is orthogonal to an axis of the connecting rod.

24. The method of manufacturing a connecting rod according to claim 19, wherein:
the first member is a big end member that forms a big end connected to a crankpin;
the second member includes a column member that forms a column portion that extends between a small end connected to a piston and the big end; and
the column member and the big end member are integrally bonded by diffusion bonding.

25. The method of manufacturing a connecting rod according to claim 24, wherein
a bonding surface bonded by the diffusion bonding conforms to an outer edge shape of the big end.

26. The method of manufacturing a connecting rod according to claim 24, wherein:
the big end member is formed in a shape in which a portion of the big end is partially cut out;
the column member is formed to include an end portion that corresponds to the cutout portion of the big end; and
the cutout portion of the big end member and the end portion of the column member are bonded by diffusion bonding.

27. The method of manufacturing a connecting rod according to claim 24, wherein
a bonding surface of the big end member with the column member is orthogonal to an axis of the connecting rod.

28. The method of manufacturing a connecting rod according to claim 24, wherein:
the first member includes a small end member that forms the small end; and
the column member and the small end member are integrally bonded by diffusion bonding.

29. The method of manufacturing a connecting rod according to claim 28, wherein
the small end member and the big end member are made of different constituent materials.

30. The method of manufacturing a connecting rod according to claim 28, wherein
a bonding surface bonded by the diffusion bonding conforms to an outer edge shape of the small end.

31. The method of manufacturing a connecting rod according to claim 28, wherein:
the small end member is formed in a shape in which a portion of the small end is partially cut out;
the column member is formed to include an end portion that corresponds to the cutout portion of the small end; and
the cutout portion of the small end member and the end portion of the column member are bonded by diffusion bonding.

32. The method of manufacturing a connecting rod according to claim 28, wherein
a bonding surface of the small end member with the column member is orthogonal to an axis of the connecting rod.
